(19) United States
(12) Patent Application Publication
(10) Pub. No.: US 2007/0152592 A1
(43) Pub. Date: Jul. 5, 2007

(54) Plasma display panel

(76) Inventors: Hyun Kim, Suwon-si (KR); Kyoung-Doo Kang, Suwon-si (KR); Se-Jong Kim, Suwon-si (KR); Hyun Soh, Suwon-si (KR); Yun-Hee Kim, Suwon-si (KR); Jin-Won Han, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/643,488

(22) Filed: Dec. 21, 2006

(30) Foreign Application Priority Data
Dec. 30, 2005 (KR) 10-2005-0135853

(51) Int. Cl. H01J 17/49

(52) U.S. Cl. 313/586

(57) ABSTRACT

A plasma display panel (PDP) having a structure that can improve the bright room contrast is disclosed. In one embodiment, the PDP includes a first substrate and a second substrate spaced apart from each other and facing each other, first electrodes formed on the first substrate, barrier ribs defining a plurality discharge cells and non-discharge areas in the space between the first and second substrates, a dielectric layer formed on the first substrate while covering the first electrodes, the dielectric layer including grooves formed in portions of the dielectric layer that correspond to the non-discharge areas, and second electrodes formed don the second electrodes.

### CROSS-REFERENCE TO RELATED PATENT APPLICATION

This application claims the benefit of Korean Patent Application No. 10-2005-0135853, filed on Dec. 30, 2005, in the Korean Intellectual Property Office, the disclosure of which is incorporated herein in its entirety by reference.

### BACKGROUND OF THE INVENTION

1. Field of the Invention

The present invention relates to a plasma display panel, and more particularly, to a plasma display panel (PDP) having a structure capable of improving the bright room contrast.

2. Description of the Related Technology

PDP apparatuses denote flat display devices that display images using a gas discharge phenomenon. PDP apparatuses provide large screens and certain advantages, such as a high-quality image display, a very thin and light design, and a wide-range viewing angle. PDP apparatuses have attracted considerable attention as the most promising large-sized flat display devices, because they can be manufactured in a simplified manner and can be easily manufactured in a large size compared with other flat display devices.

Such a PDP apparatus includes as a fundamental component a PDP that displays an image by causing phosphors to emit light with the use of ultraviolet light generated during gas discharge.

Such PDPs are classified into a direct current (DC) type, an alternating current (AC) type, and a hybrid type according to discharge voltages applied to discharge cells. PDPs may also be classified into an opposed discharge type and a surface discharge type according to the type of a discharge structure.

Opposed discharge PDPs have a lifespan shortened due to degradation of phosphor caused by ions. Meanwhile, surface discharge PDPs minimize the degradation of phosphor by concentrating discharge on a surface of a PDP opposite to the phosphor, so that problems of opposed discharge PDPs can be greatly overcome. In recent years, surface discharge PDPs are generally used.

In the structure of a general surface discharge PDP, address electrodes are arranged in a direction on a rear substrate, and a dielectric layer is formed on the entire surface of the rear substrate on which the address electrodes are arranged. Barrier ribs are arranged on the dielectric layer so as to be located between adjacent address electrodes. Red, green, and blue phosphor layers are formed between adjacent barrier ribs.

Discharge sustain electrodes each including a pair of transparent electrodes and a bus electrode are arranged on a surface of a front substrate that faces the rear substrate, and cross the address electrodes. A dielectric layer and a protection layer are formed on the entire surface of the front substrate on which the discharge sustain electrodes are formed.

PDPs may also be classified into a striped type, a matrix type, and a type including a non-discharge region, according to the shapes of barrier ribs and discharge sustain electrodes that define discharge cells.

Striped type PDPs include barrier ribs arranged in a striped pattern between adjacent address electrodes. In such striped type PDPs, discharge cells are defined in areas where the address electrodes on a rear substrate cross discharge sustain electrodes on a front substrate.

However, in PDPs having bar-shaped discharge sustain electrodes and strip-shaped barrier ribs, crosstalk may occur between neighboring discharge cells discharge cells in each line parallel to a direction in which the barrier ribs are arranged are connected to one another, so that erroneous discharge is likely to occur between adjacent discharge cells. To prevent this problem, neighboring discharge sustain electrodes that belong to different pixels need to be apart from each other a predetermined distance or greater. This measure reduces the occurrence of erroneous discharge but at the same time degrades the discharge efficiency. Thus, this measure is not a perfect solution.

To solve this problem, proposed is a structure in which while keeping a striped barrier rib structure, transparent electrodes of the discharge sustain electrodes protrude from bus electrodes, and transparent electrodes in pairs face each other in each discharge cell. A conventional PDP having the above-proposed structure is disclosed in U.S. Pat. No. 5,661,500.

However, the PDP disclosed in U.S. Pat. No. 5,661,500 does not satisfactorily reduce the occurrence of erroneous discharge parallel to a direction in which barrier ribs are arranged. Hence, a new PDP having a matrix type barrier structure has been proposed. A PDP having such a matrix type barrier structure is disclosed in Japanese Patent Publication No. hei 10-149771.

However, in the matrix type barrier structure, all areas other than barrier ribs are designed as discharge areas, and thus only heat generating areas exist. In other words, no heat absorbing/discharging areas exist, so that cells where discharge occurs for a predetermined period of time and the other cells where no discharge occurs have different temperatures. This causes problems related to the quality of image, such as, degradation of discharge characteristics, image streaking, image retention, etc.

To address the above-described problem of the matrix type barrier structure, a PDP having a barrier rib structure designed to define non-discharge areas as well as discharge cells has been proposed. Such a PDP is disclosed in Korean Patent Publication No. 2004-0062381.

The non-discharge areas do not receive special voltages and thus are not supposed to generate discharge or emit light. These non-discharge areas contribute to increasing the discharge efficiency and securing stable discharge.

Despite of these advantages, the PDP including non-discharge areas still have a problem which is a low bright-room contrast. In many cases, display devices usually display images in bright situations. Hence, if the bright room contrast of a display device is low, the display device is not able to provide a clear image to viewers.

FIG. 1 is a view for illustrating a problem related to a bright room contrast that is generated in a conventional PDP. Referring to FIG. 1, reference numeral 1 denotes a front panel, reference numeral 2 denotes a rear panel, and reference numeral 3 denotes a chassis base. Arrows indicated by a solid line denote visible light that come out of the PDP, and arrows indicated by a dotted line denote external visible light that is reflected by the front panel 1. As the amount of reflected light is larger, degradation of the bright room contrast becomes worse. The reason why a PDP has a low bright-room contrast is that much visible light is reflected by a front panel of the PDP.

### SUMMARY OF CERTAIN INVENTIVE ASPECTS

One aspect of the present invention provides a plasma display panel (PDP) in which portions of a dielectric layer that correspond to non-discharge areas are slanted, and the slanted portions absorb external visible light, so that the amount of light reflected by a front panel is reduced, thereby increasing the bright room contrast. Another aspect of the invention provides a high quality PDP having a high bright-room contrast by developing a structure that can reduce the amount of light reflected by a front panel.

According to another aspect of the present invention, there is provided a PDP including: i) a first substrate and a second substrate spaced apart from each other and facing each other, ii) first electrodes formed on the first substrate, iii) barrier ribs defining a plurality discharge cells and non-discharge areas in the space between the first and second substrates iv) a dielectric layer formed on the first substrate while covering the first electrodes, the dielectric layer including grooves formed in portions of the dielectric layer that correspond to the non-discharge areas and v) second electrodes formed don the second electrodes.

According to another aspect of the present invention, there is provided a PDP including: i) a first substrate and a second substrate spaced apart from each other and facing each other, ii) first electrodes formed on the first substrate, iii) barrier ribs defining a plurality discharge cells and non-discharge areas in the space between the first and second substrates iv) a dielectric layer formed on the first substrate while covering the first electrodes, the dielectric layer including grooves formed in portions of the dielectric layer that correspond to the non-discharge areas, v) phosphor layers formed within the discharge cells and vi) second electrodes formed on the second electrodes, wherein the non-discharge areas are located within areas defined by horizontal lines and vertical lines that pass through the centers of the discharge cells.

According to still another aspect of the present invention, there is provided a PDP including: i) a first substrate and a second substrate spaced apart from each other and facing each other, ii) first electrodes formed on the first substrate, iii) barrier ribs defining a plurality discharge cells and non-discharge areas in the space between the first and second substrates, iv) a dielectric layer formed on the first substrate while covering the first electrodes, the dielectric layer including grooves formed in portions of the dielectric layer that correspond to the non-discharge areas, v) phosphor layers formed within the discharge cells, vi) coloring layers with which the grooves are filled and vii) second electrodes formed on the second electrodes.

### BRIEF DESCRIPTION OF THE DRAWINGS

Embodiments of the present invention will be described with reference to the attached drawings.

FIG. 1 illustrates visible light coming out of discharge cells of a conventional plasma display panel (PDP) and external visible light reflected by a first panel (i.e., a front panel) of the convention PDP.

FIG. 2 is an exploded perspective view of a portion of a PDP according to an embodiment of the present invention.

FIG. 3 is a plan view of the portion of the PDP of FIG. 2.

FIG. 4 is a cross-section taken along line V-V of FIG. 3.

FIG. 5 is a cross-section of a portion of a PDP according to another embodiment of the present invention that corresponds to the cross-section of FIG. 4.

FIG. 6 is a cross-section of a portion of a PDP according to another embodiment of the present invention that corresponds to the cross-section of FIG. 4.

FIG. 7 is a plan view of a portion of a PDP according to another embodiment of the present invention that corresponds to the plan view of FIG. 3.

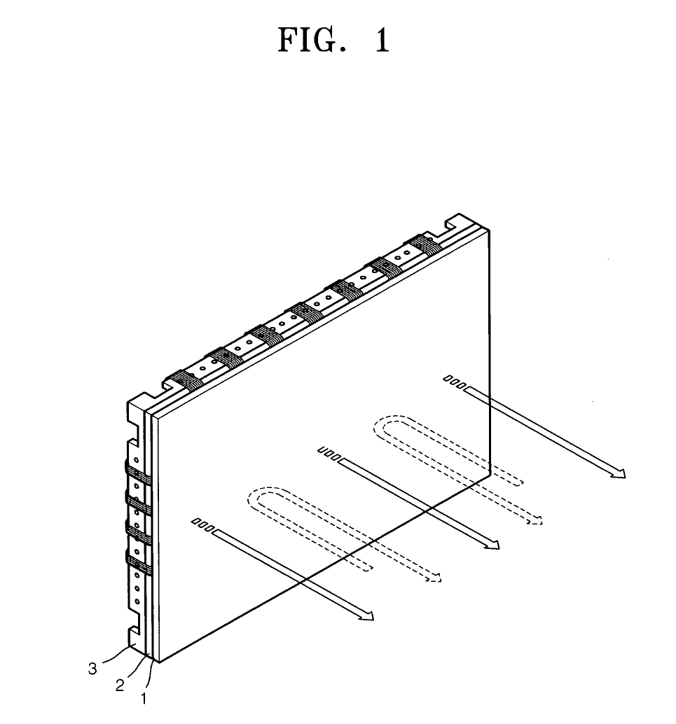

### DETAILED DESCRIPTION OF CERTAIN INVENTIVE EMBODIMENTS

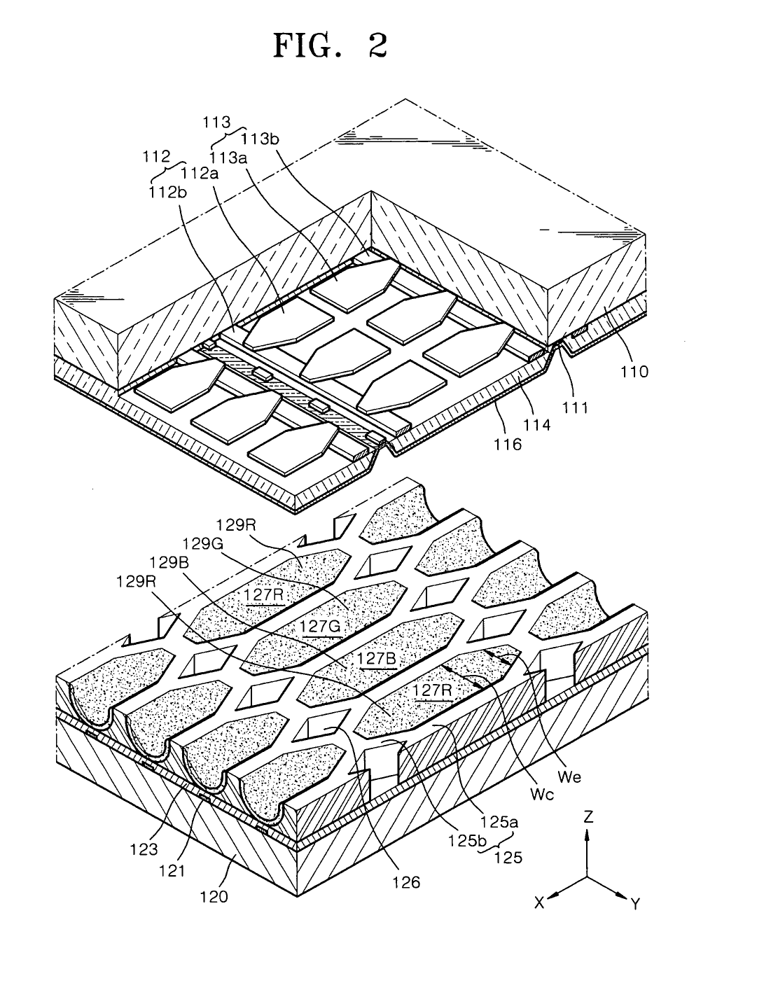

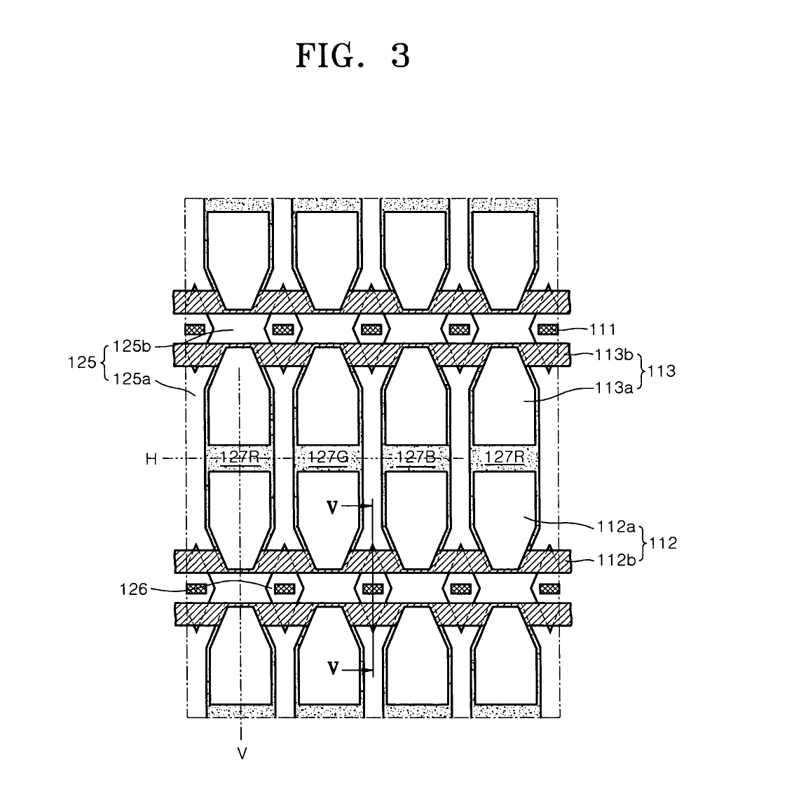

FIGS. 2 through 4 illustrate a PDP according to an embodiment of the present invention. FIG. 2 is an exploded perspective view of a portion of the PDP according to an embodiment of the present invention. FIG. 3 is a plan view of the portion of the PDP of FIG. 2.

Referring to FIGS. 2 and 3, a first substrate 110 and a second substrate 120 face each other and are a predetermined distance apart from each other. A plurality of discharge cells 127R, 127G, and 127B are defined in between the first and second substrates 110 and 120 by barrier ribs 125 and generate plasma discharge. A plurality of first electrodes 112 and 113 and a plurality of second electrodes 121 are arranged on the first and second substrates 110 and 120, respectively. The first electrodes 112 and 113 and the second electrodes 121 are covered with a first dielectric layer 114 and a second dielectric layer 123, respectively.

More specifically, the second electrodes 121 are arranged in the x-axis direction on a surface of the second substrate 120 that faces the first substrate 110. The first and/or second substrates 110 and/or 120 are panels having predetermined thicknesses. For example, the first and/or second substrates 110 and/or 120 may be a quartz glass, a glass including impurities like a small amount of Na, a plate glass, a glass substrate coated with SiO2, or an aluminum oxide or ceramic substrate.

The second electrodes 121 in strips are arranged parallel to each other at predetermined intervals. The second dielectric layer 123 is formed on the second substrate 120 on which the second electrodes 121 are formed. The second dielectric layer 123 may be formed on the entire surface of the second substrate 120 while covering the address electrodes 121. Although the strip-shaped second electrodes 121 are illustrated in FIG. 2, the present invention is not limited thereto. The second electrodes may have the other various shapes.

The barrier ribs 125 are arranged in the space between the first and second substrates 110 and 120 and define the discharge cells 127R, 127G, and 127B and non-discharge areas 126. In one embodiment, the barrier ribs 125 are formed on the upper surface of the second dielectric layer 123. The discharge cells 127R, 127G, and 127B are configured to generate gas discharge in response to an address voltage or a discharge sustain voltage, because they include a discharge gas. Generally, the non-discharge areas 126 do not receive a special voltage and accordingly are not configured to generate discharge or light emission. In one embodiment, the non-discharge areas 126 are larger than at least the width of an upper surface of each of the barrier ribs 125.

In the embodiment of FIGS. 2 and 3, the non-discharge areas 126 are located at the centers of virtual rectangles defined by virtual horizontal lines H and virtual vertical lines V that pass through the centers of the discharge cells 127R, 127G, and 127B. In other words, each of the non-discharge areas 126 is shared by two pairs of discharge cells that are adjacent to one another horizontally and vertically. The non-discharge areas 126 are independent cells defined by the barrier ribs 125. However, the present invention is not limited to the cell structure, and the non-discharge areas 126 may have the other structures, such as, elongate structures extending in a direction.

Every two discharge cells of the discharge cells 127R, 127G, and 127B adjacent to each other in the arrangement direction of the first electrodes 112 and 113 share at least one barrier rib. In other words, referring to FIG. 2, a width Wc of each of the discharge cells 127R, 127G, and 127B at its center is larger than a width We of each of the discharge cells 127R, 127G, and 127B at its end. The width We decreases as going away from the center of each of the discharge cells 127R, 127G, and 127B. In one embodiment, both end portions of the discharge cells 127R, 127G, and 127B as viewed in the arrangement direction of the second electrodes 121 are trapezoid, and accordingly the overall shapes of the discharge cells 127R, 127G, and 127B are octagonal. However, the present invention is not limited to the octagonal shape, and the discharge cells 127R, 127G, and 127B may have the other shapes.

The barrier ribs 125, defining the discharge cells 127R, 127G, and 127B and the non-discharge areas 126, may be made up of first barrier elements 125a substantially parallel to the second electrodes 121 and second barrier elements 125b not substantially parallel to the second electrodes 121. In one embodiment, the second barrier elements 125b cross the second electrodes 121. In particular, the second barrier elements 125b may form an approximately X shape between neighboring discharge cells 127R, 127G, and 127B.

Red (R), green (G), and blue (B) phosphor layers 129R, 129G, and 129B are formed by coating R, G, and B phosphors within the discharge cells 127R, 127G, and 127B. In one embodiment, the phosphor layers 129R, 129G, and 129B substantially completely fill the discharge cells 127R, 127G, and 127B and have components that generate visible light in response to UV light. For example, the R phosphor layers 129R, emitting red visible light, may be formed of phosphor, such as, Y(V,P)04:Eu, the G phosphor layers 129G, emitting green visible light, may be formed of phosphor, such as, ZN2SiO4:Mn, and the B phosphor layers 129B, emitting blue visible light, may be formed of phosphor, such as, BAM:Eu.

A plurality of excitation gas particles including xenon (Xe) may be injected into the discharge cells 127R, 127G, and 127B. Instead of xenon (Xe), the excitation gas (or a discharge gas) particles may include at least one of nitrogen (N2), heavy hydrogen (D2), carbon dioxide (CO2), hydrogen (H2), carbon monoxide (CO), neon (Ne), helium (He), argon (Ar), the air with an air pressure, krypton (Kr), etc.

The first substrate 110 illustrated on the upper part of FIG. 2 will now described in greater detail. The first substrate 110 is formed of a transparent or semi-transparent material so as to transmit visible light. The first electrodes 112 and 113 are formed on an inner surface of the first substrate 110, that is, on a surface of the first substrate 110 facing the second substrate 120, and are arranged in the y-axis direction, that is, cross the second electrodes 121 on the second substrate 120.

The first electrodes 112 and 113 include bus electrodes 112b and 113b, respectively, in strips, and protruding electrodes 112a and 113a, respectively, extending from the bus electrodes 112b and 113b toward the centers of the discharge cells 127R, 127G, and 127B. Every pair of bus electrodes 112b and 113b corresponds to each of the discharge cells 127R, 127G, and 127B. Protruding electrodes 112a and 113a in every pair face each other. Every pair of protruding electrodes 112a and 113a narrows as going from the center of each of the discharge cells 127R, 127G, and 127B to both ends thereof. Ends of protruding electrodes 112a and 113a in every pair that are close to each other correspond to the center of each of the discharge cells 127R, 127G, and 127B, and the other ends that are far from each other correspond to both ends of each of the discharge cells 127R, 127G, and 127B. The protruding electrodes 112a and 113a may be formed so that both edges of each of the ends of the protruding electrodes 112a and 113a corresponding to the both ends of each of the discharge cells 127R, 127G, and 127B are lined up with the inner walls of each of the discharge cells 127R, 127G, and 127B. In particular, the ends of the protruding electrodes 112a and 113a that are far from each other have trapezoid shapes that conform to the shapes of the ends of each of the discharge cells 127R, 127G, and 127B.

The protruding electrodes 112a and 113a may be transparent electrodes, for example, indium tin oxide (ITO) electrodes. In one embodiment, metal electrodes may be used as the bus electrodes 112b and 113b.

The first dielectric layer 114 is formed on the inner surface of the first substrate 110 while covering the first electrodes 112 and 113. The first dielectric layer 114 is generally formed on the entire surface of a substrate. In a conventional PDP, a dielectric layer is formed to have a uniform thickness across a surface of a substrate. Meanwhile, in one embodiment of the invention, a predetermined area of the upper surface of the first dielectric layer 114 is etched to form grooves therein so that at least a portion of the first dielectric layer 114 is different in thickness from the remaining portion of the layer 114.

In one embodiment, the grooves are formed on areas of the surface of the first dielectric layer 114 that are opposite to the non-discharge areas 126, and are arranged substantially in the same direction as the direction in which the bus electrodes 112b and 113b extend. In particular, the grooves are formed not between bus electrodes 112a and 113a in pairs for each discharge cell but between bus electrodes that are adjacent to each other as viewed in the extending direction (i.e., the X direction of FIG. 2) of the second electrodes 121 and belong to different discharge cells. However, the grooves may be arranged in the other various ways as long as the grooves are arranged opposite to the non-discharge areas 126.

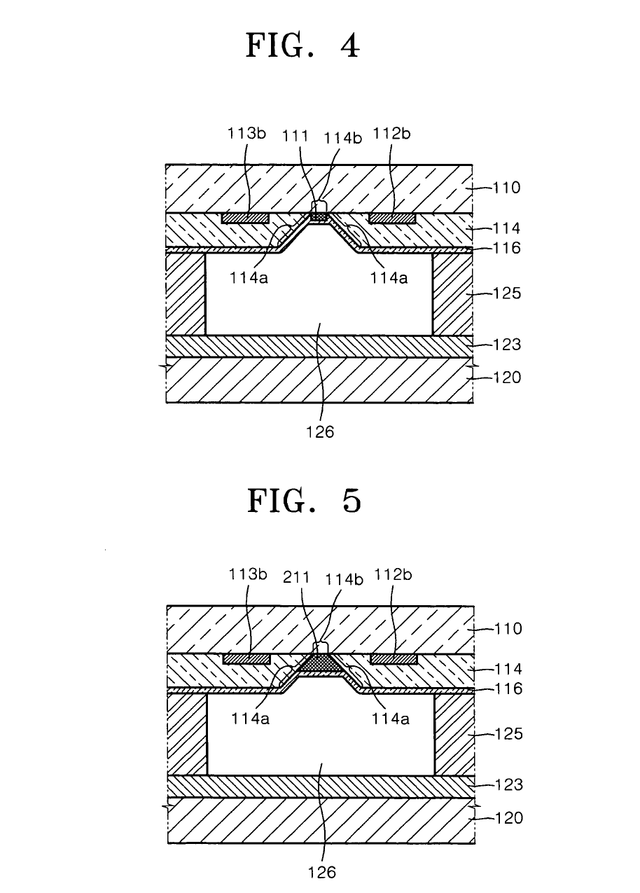

A slanted portion of the first dielectric layer 114 can be more easily understood referring to FIG. 4. FIG. 4 is a cross-section taken along line V-V of FIG. 3. The structure of a portion ranging from the first substrate 110 to the second substrate 120 for one non-discharge area is illustrated in FIG. 4.

Referring to FIG. 4, each of the grooves formed in the first dielectric layer 114 includes a slanted portion (or slanted wall) 114a having a predetermined inclination and a flat portion (or wall) 114b parallel to the first substrate 110.

Visible light incident upon the first substrate 110 is scattered by the slanted portion 114a, so that the slanted portion 114a appears black as viewed from the outside of the first substrate 110. Accordingly, the reflectivity of external light decreases, leading to an improvement of the dark room contrast of a PDP. In one embodiment, the dark room contrast of a PDP is improved.

In one embodiment, the grooves including the slanted portions 114a extend in one direction. However, the grooves may discontinue in one direction so that separate grooves face the non-discharge areas 126.

A black visible light absorbing material (hereinafter, referred to as coloring layers 111) is formed on portions of the flat portion 114b that face the non-discharge areas 126. The coloring layers 111 are also called a black stripe pattern or a black matrix and are formed of a material that can absorb external light (i.e., visible light) to reduce the reflection of the external light. If the coloring layers 111 are formed of this material, the coloring layers 111 does not need to be black. The coloring layers 11 may be very thinly formed on the flat portion 114b. The coloring layer 111 and the first dielectric layer 114 are covered with a protective layer 116 to be described later.

In one embodiment, as illustrated in FIG. 3, the coloring layers 111 have rectangular plane shapes and face the non-discharge areas 126. However, the present invention is not limited to the rectangular plane shapes, and the coloring layers 111 may be formed long along the flat portions 114b. The coloring layers 111 absorb the external light. Hence, the reflection of the external light is reduced, whereby the bright room contrast is increased. In addition, the coloring layers 111 face the non-discharge areas 126 that are separated from the discharge cells 127R, 127G, and 127B where light emission occurs, so that visible light coming out of the phosphor layer 129R, 129G, and 129B is not absorbed into the coloring layers 111.

The protection layer 116 is formed of a material, such as, magnesium oxide (MgO), on the first dielectric layer 114 and protects the first dielectric layer 114. The protection layer 116 protects the first dielectric layer 114 by preventing a dielectric material of the first dielectric layer 114 from being sputtered due to ion bombardment. Alternatively, the protection layer 116 may be formed of a material, such as, magnesium fluoride (MgF2).

PDPs according to embodiments of FIGS. 5, 6, and 7 will now be described. The PDPs of FIGS. 5, 6, and 7 have the same basic structures as the PDP of FIGS. 2-4. However, coloring layers (i.e., black strips) or slanted portions of the PDPs according to the embodiments of FIGS. 5, 6, and 7 have different structures than the PDP according to the embodiment illustrated in FIGS. 2-4 so that the bright room contrast is improved. Like elements are indicated by like reference numerals throughout the embodiments, and descriptions of the embodiments will be focused on distinguished structures.

FIG. 5 is a cross-section of a portion of a PDP according to another embodiment of the present invention that corresponds to the cross-section of FIG. 4.

In one embodiment, coloring layers 211 are formed to have heights corresponding to about half the height of the first dielectric layer 114. When viewed from the front side of the PDP of FIG. 5, an area of the PDP occupied by the coloring layers 211 is larger than that of the PDP according to the embodiment illustrated in FIGS. 5, 6, and 7, so that the absorptance of external light is increased. Scattering and/or absorption of the external light are generated by the slanted portions 114a of grooves and the coloring layers 211.

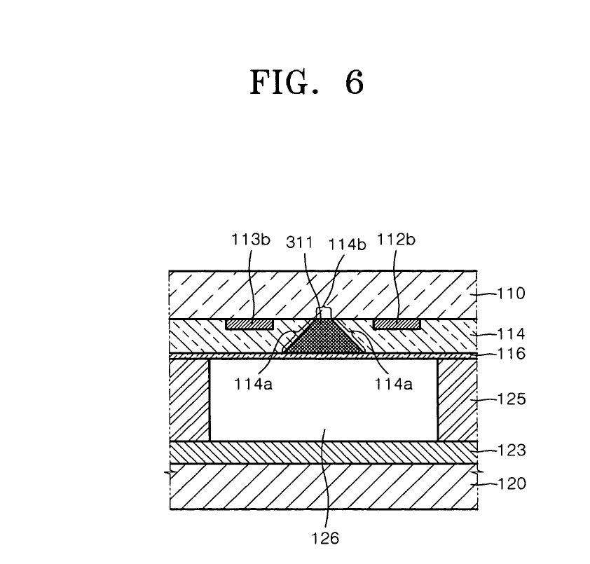

FIG. 6 is a cross-section of a portion of a PDP according to another embodiment of the present invention that corresponds to the cross-section of FIG. 4.

In one embodiment, coloring layers 311 are formed to have substantially the same heights as the height of the first dielectric layer 114. When viewed from the front side of the PDP of FIG. 6, an area of the PDP occupied by the coloring layers 311 is maximized, so that the absorptance of external light is very high. Scattering and/or absorption of the external light are generated by the slanted portions 114a of grooves and the coloring layers 311.

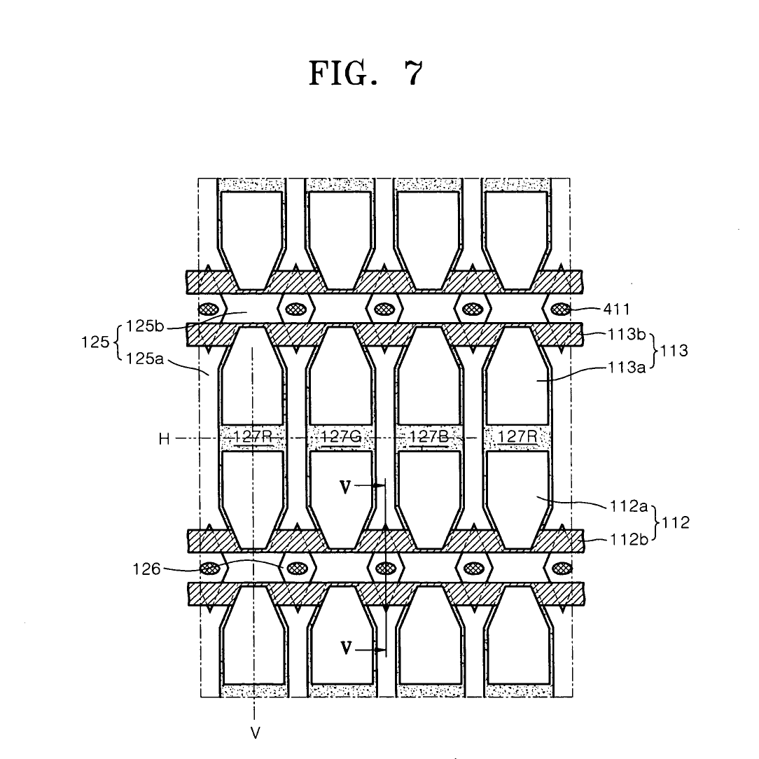

FIG. 7 is a plan view of a portion of a PDP according to another embodiment of the present invention that corresponds to the plan view of FIG. 3.

Referring to FIG. 7, color layers 411 have oval plane shapes. However, the color layers 411 may have the other various shapes, such as, a circle and all kinds of polygons. Furthermore, although the color layers 411 discontinuously formed to correspond to non-discharge areas are illustrated in FIG. 7, they may extend along grooves.

In a PDP according to at least one embodiment of the present invention, grooves inclined with respect to a dielectric layer of a front panel are included, so that external light is scattered by or absorbed into the grooves. Therefore, the amount of light reflected by the front panel is reduced, and the bright room contrast is improved.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display panel (PDP), comprising:
a first substrate and a second substrate spaced apart from each other and facing each other;
a plurality of first electrodes formed on the first substrate;
a plurality of barrier ribs defining a plurality of discharge cells and non-discharge areas in the space between the first and second substrates;
a dielectric layer formed on the first substrate and covering the first electrodes, wherein at least one groove is defined in portions of the dielectric layer that correspond to the non-discharge areas; and
a plurality of second electrodes formed on the second substrate.

2. The PDP of claim 1, wherein the at least one groove includes slanted walls which are not parallel to the first substrate.

3. The PDP of claim 2, wherein the width of the at least one groove becomes smaller along a direction from the barrier ribs to the first substrate.

4. The PDP of claim 2, wherein the at least one groove further includes a wall which is substantially parallel to the first substrate and connected to both ends of the slanted portions.

5. The PDP of claim 1, wherein the non-discharge areas are located within areas surrounded by four adjacent discharge cells.

6. The PDP of claim 1, further comprising a coloring layer formed on at least a portion of the groove.

7. The PDP of claim 6, wherein the coloring layer is formed on a substantially bottom portion of the groove which is closer to the first substrate than the barrier ribs.

8. The PDP of claim 6, wherein the coloring layer substantially fills the entire area of the groove.

9. The PDP of claim 6, wherein the coloring layer is formed of a material which is configured to substantially absorb visible light received from the outside of the first substrate.

10. The PDP of claim 6, wherein the coloring layer comprises a material having a black color.

11. A plasma display panel (PDP) device, comprising:
a PDP substrate configured to display images; and
a dielectric layer, formed on the PDP substrate, having a first portion corresponding to a discharge area and a second portion corresponding to a non-discharge area, wherein at least part of the second portion has a thickness less than that of the first portion.

12. The PDP of claim 11, wherein a groove is defined in the part of the second portion.

13. The PDP of claim 12, wherein the groove has an entrance and a bottom, wherein the bottom is closer to the PDP substrate than the entrance, and wherein the width of the entrance is greater than that of the bottom.

14. The PDP of claim 12, further comprising a coloring layer formed on at least a portion of the groove.

15. The PDP of claim 14, wherein the coloring layer substantially fills the entire area of the groove.

16. The PDP of claim 14, further comprising a protective layer formed on the entire surface of the dielectric layer and the coloring layer.

17. The PDP of claim 11, further comprising a plurality of barrier ribs defining a plurality of discharge cells, wherein the non-discharge area is surrounded by four adjacent discharge cells.

18. A method of using a plasma display panel (PDP) device, comprising:
providing a dielectric layer on a PDP substrate, wherein the dielectric layer has a first portion corresponding to a discharge area and a second portion corresponding to a non-discharge area, and wherein a groove is defined in the second portion; and
absorbing, at the second area, at least a portion of external light received from the outside of the PDP substrate.

19. The method of claim 18, further comprising providing a plurality of barrier ribs defining a plurality of discharge cells, wherein the non-discharge area is surrounded by four adjacent discharge cells.

20. The method of claim 18, further comprising scattering at least part of the external light by way of the groove.
